(19) United States
(12) Patent Application Publication
(10) Pub. No.: US 2010/0317438 A1
(43) Pub. Date: Dec. 16, 2010

(54) GAME DEVICE AND GAME CONTROL METHOD FOR CONTROLLING GAME OF ARRANGING OBJECTS IN PREDEFINED ORDER

(75) Inventors: Daisaku Ikejiri, Tokyo (JP); Masashi Muramori, Kanagawa (JP)

Correspondence Address: KATTEN MUCHIN ROSENMAN LLP, 575 MADISON AVENUE, NEW YORK, NY, 10022-2585, US

(73) Assignee: SONY COMPUTER ENTERTAINMENT INC., Tokyo (JP)

(21) Appl. No.: 12/813,805

(22) Filed: Jun. 11, 2010

(30) Foreign Application Priority Data
Jun. 12, 2009 (JP) 2009-141582

(51) Int. Cl. A63F 13/06; A63F 9/24

(52) U.S. Cl. 463/36; 463/43

(57) ABSTRACT

A game device includes: an object arrangement modification unit adapted to acknowledge selection of an object subject to movement from among a plurality of objects arranged in one direction in a game field, and to move the selected object to a position requested by a user; a determination unit adapted to refer to a table storing a proper order of arrangement of the plurality of objects, determine whether objects that should be arranged adjacent to each other are properly placed in adjacent positions, and group those objects that are properly placed in adjacent positions if any. The object arrangement modification unit moves the plurality of objects belonging to a group in a block when the grouped objects are selected.

### BACKGROUND OF THE INVENTION

1. Field of the Invention

The present invention relates to a game control technology and, more particularly, to a game control program, game device, and a game control method for controlling a game of arranging objects in a predefined order.

2. Description of the Related Art

Puzzle games are popular in which a plurality of objects are caused to drop in a game field, and objects are arranged so as to meet a predefined condition and deleted.

Various types of puzzle games with uniquely designed objects shapes and arrangements are provided. There is a need for a puzzle game that can be enjoyed by a wide variety of users in a leisurely manner.

### SUMMARY OF THE INVENTION

The present invention addresses a situation like this and a purpose thereof is to provide a game control technology capable of providing high entertainment values.

One embodiment of the present invention relates to a game control program. The game control program comprises: a module adapted to acknowledge selection of an object subject to movement from among a plurality of objects arranged in one direction in a game field; a module adapted to move the selected object to a position requested by a user; and a module adapted to refer to a table storing a proper order of arrangement of the plurality of objects, determine whether objects that should be arranged adjacent to each other are properly placed in adjacent positions, and group those objects that are properly placed in adjacent positions if any, wherein the module for moving moves the plurality of objects belonging to a group in a block when the grouped objects are selected.

Optional combinations of the aforementioned constituting elements, and implementations of the invention or the elements thereof in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of a game device according to the embodiment;

FIG. 2 shows an exemplary screen displayed on the display device;

FIG. 3 shows exemplary data contained in the object management table;

FIG. 4 shows an exemplary screen displayed on the display device;

FIG. 5 shows an exemplary screen displayed on the display device;

FIG. 6 shows an exemplary screen displayed on the display device;

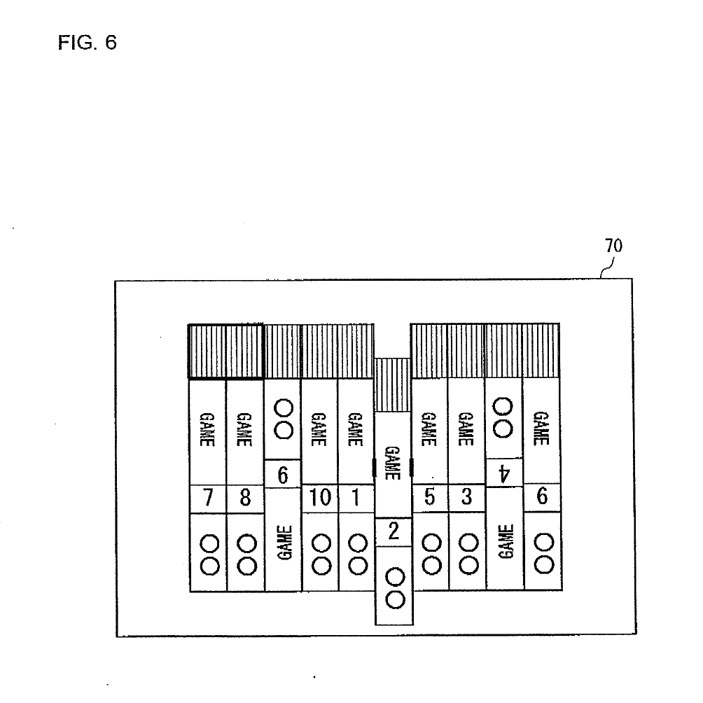

FIG. 7 shows an exemplary screen displayed on the display device;

FIG. 8 shows an exemplary screen displayed on the display device;

FIG. 9 shows an exemplary screen displayed on the display device;

FIG. 10 shows an exemplary screen displayed on the display device;

FIG. 11 shows an exemplary screen displayed on the display device;

FIG. 12 shows an exemplary screen displayed on the display device;

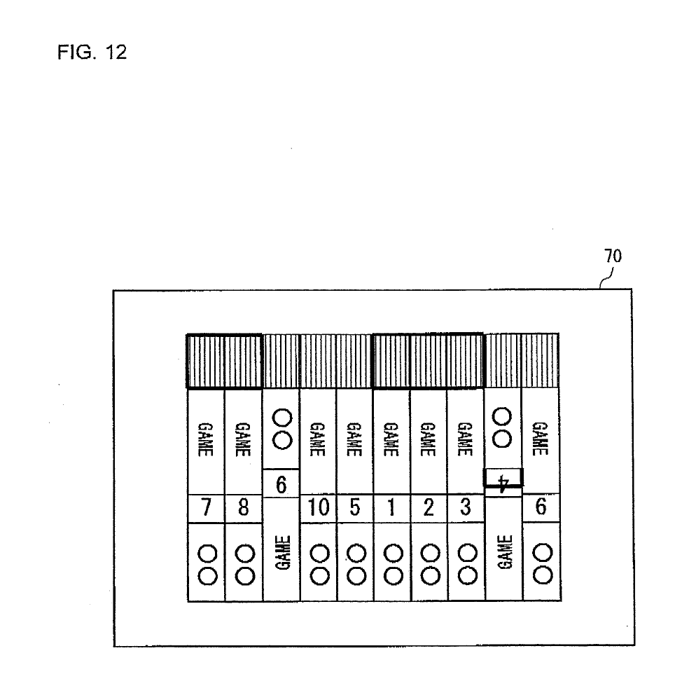

FIG. 13 shows an exemplary screen displayed on the display device;

FIG. 14 shows an exemplary screen displayed on the display device;

FIG. 15 shows an exemplary screen displayed on the display device;

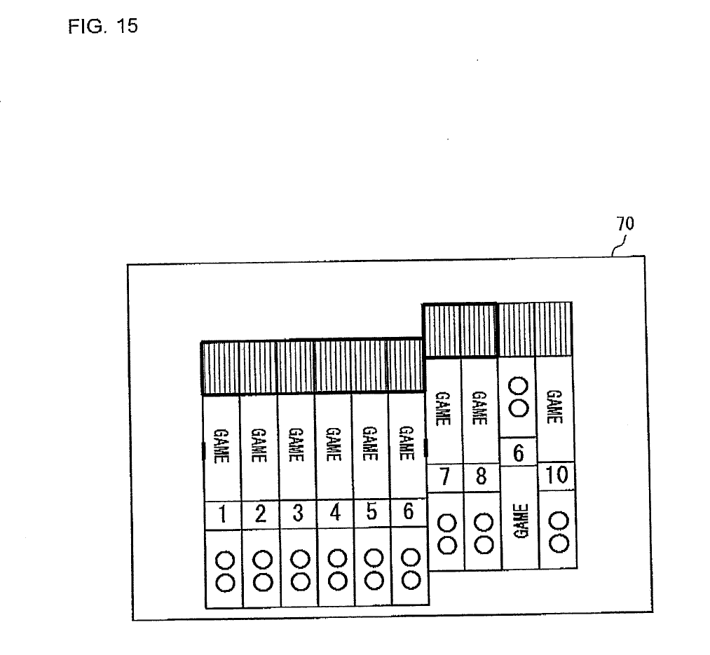

FIG. 16 shows an exemplary screen displayed on the display device; and

FIG. 17 shows an exemplary screen displayed on the display device.

### DETAILED DESCRIPTION OF THE INVENTION

The invention will now be described by reference to the preferred embodiments. This does not intend to limit the scope of the present invention, but to exemplify the invention.

The game device according to an embodiment provides a game in which multiple objects arranged in one direction in a game field are rearranged in a predefined order. The description of the embodiment concerns an exemplary game in which a plurality of books arranged horizontally in a game field depicted as a book shelf are rearranged in the order of volumes.

The game device according to the embodiment provides a function of simplifying the user operation so that the game can be enjoyed by a wide variety of users. For example, when objects that should be arranged adjacent to each other are actually properly placed in adjacent positions during the process of rearrangement, the function makes it possible to group the objects so that the objects are moved (relocated) in a block. Alternatively or additionally, the game device provides a function of automatically rotating objects that had been oppositely oriented in the arrangement and that are taken out for relocation. By providing such a function, a game is provided that can be enjoyed by a wide variety of users in a leisurely manner.

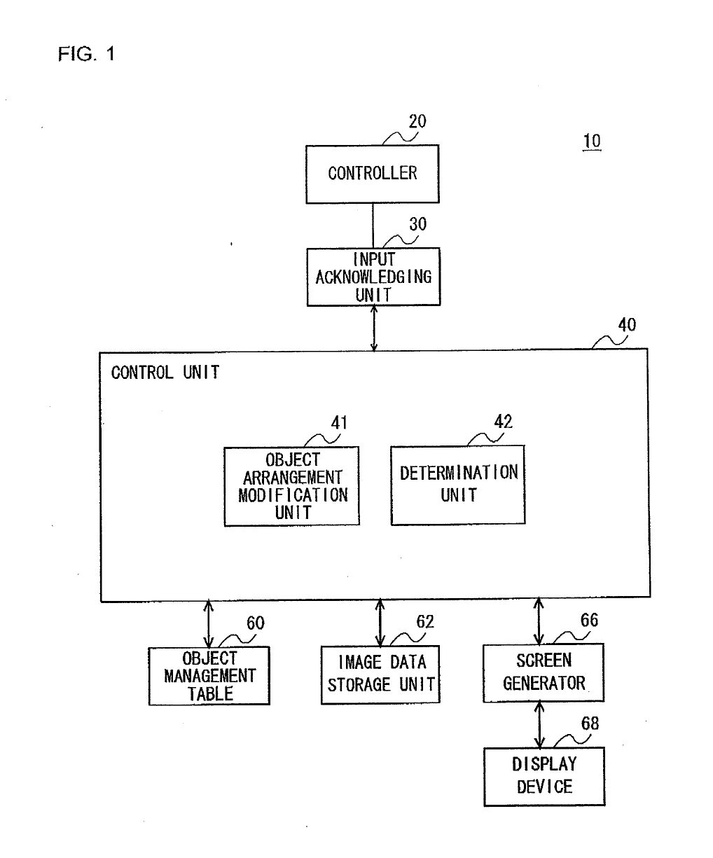

FIG. 1 shows the configuration of a game device 10 according to the embodiment. The game device 10 comprises a controller 20, an input acknowledging unit 30, a control unit 40, an object management table 60, an image data storage unit 62, a screen generator 66, and a display device 68. The configuration is implemented, in hardware components, by any CPU of a computer, a memory, and in software by a program or the like loaded into the memory. FIG. 1 depicts functional blocks implemented by the cooperation of hardware and software. Therefore, it will be obvious to those skilled in the art that the functional blocks may be implemented in a variety of manners by hardware only, software only, or a combination of thereof.

The input acknowledging unit 30 acknowledges a control signal input from the controller 20 manipulated by the user. The control unit 40 controls the arrangement of objects in a game field in accordance with a control input from the player acknowledged by the input acknowledging unit 30, so as to advance the game. The screen generator 66 generates a screen of a game controlled by the control unit 40 and displays the screen on the display device 68.

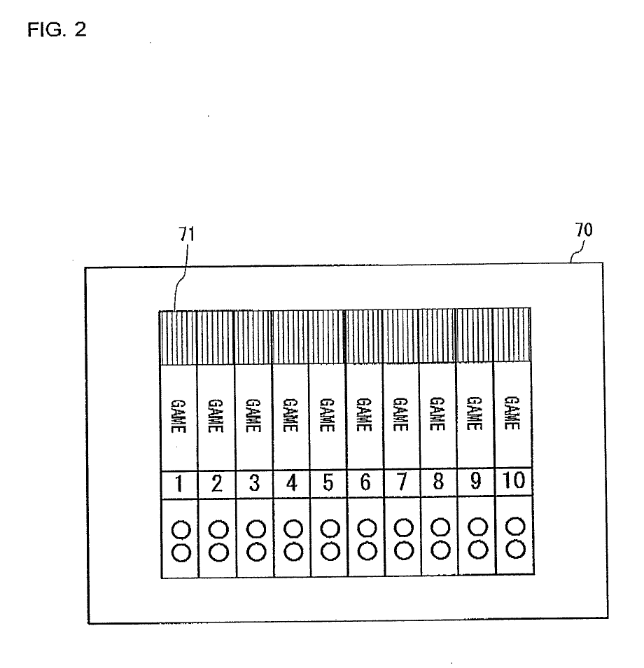

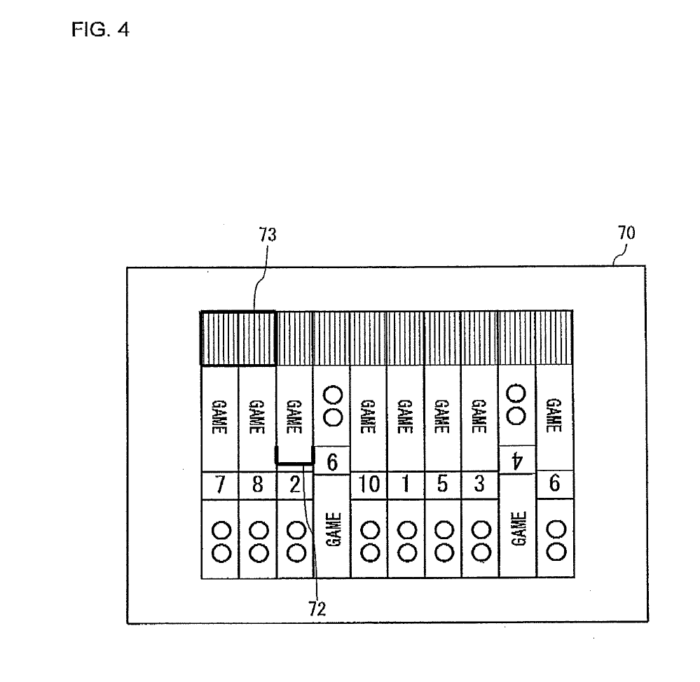

FIG. 2 shows an exemplary screen displayed on the display device 68. The display screen displays multiple books 71 arranged horizontally in the order of volumes. The illustrated screen is displayed when the game is cleared. When the game is started, multiple books are arranged at random as shown in FIG. 4. The user moves and rearranges the books so that the books are as shown in FIG. 2.

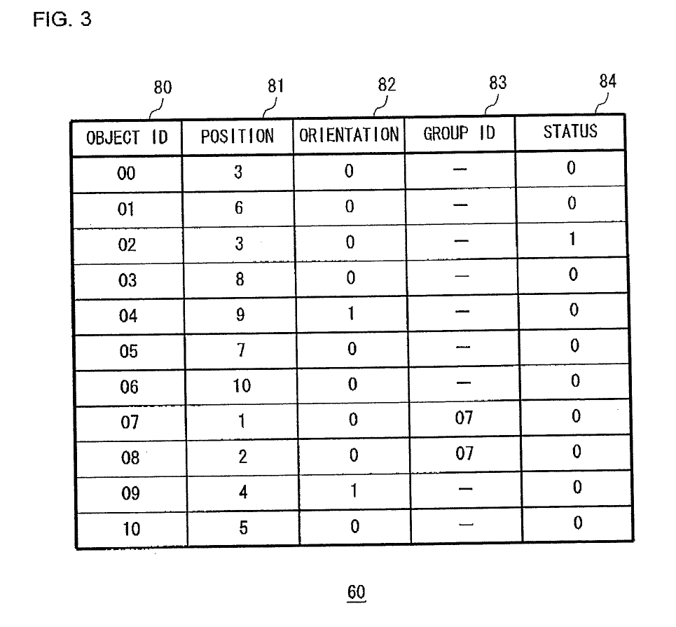

FIG. 3 shows exemplary data contained in the object management table 60. The object management table 60 is provided with an object ID column 80, a position column 81, an orientation column 82, a group ID column 83, and a status column 84. The object ID column 80 stores the IDs of objects. In this embodiment, object IDs are assigned in the order of arrangement of objects. An object ID not only identifies the object but also is used to determine the order of arrangement of objects. The position column 81 stores data indicating the position of the object in the game field. In this embodiment, objects are arranged in one direction in the game field so that the data indicating the position may be one-dimensional data. The orientation column 82 stores data indicating the orientation in which the object is arranged. As mentioned before, objects may be orientated oppositely in the arrangement and so the orientation column 82 is provided. In this embodiment, a proper orientation is indicated by an entry “0” in the table. An inverted orientation is indicated by “1”. The group ID column 83 stores an ID for identifying a group when multiple objects are grouped. In this embodiment, the object ID of an object that belongs to a group of multiple objects and that is assigned the smallest object ID is used as a group ID. In the example of FIG. 3, the object with an object ID “07” and the object with an object ID “08” are grouped. A group ID “07” is stored in the table. A separate management table that manages groups may be provided. The status column 84 stores the status of the object. As described below, an object is pulled out (selected) and moved rightward or leftward according to the embodiment. In a state in which the object is pulled out (selected state), “1” is stored. In an ordinary state (non-selected stated), “0” is stored.

Referring back to FIG. 1, a description of the control unit 40 will be continued. An object arrangement modification unit 41 modifies the arrangement of multiple objects arranged in the game field in accordance with user control. For example, the object arrangement modification unit 41 moves, in the game field, a cursor indicating an object subject to rearrangement in accordance with a control input provided via, for example, a cross key of the controller 20. The unit 41 then changes the current position of the cursor as managed by the object management table 60. Further, the object arrangement modification unit 41 displays the object at the cursor position being pulled out in accordance with a control input provided via, for example, a button of the controller 20 and updates the status column of the object management table 60 accordingly. When a control input provided via, for example, a cross key of the controller 20 is acknowledged while the object is being pulled out, the unit 41 shows the object pulled out and the object adjacent to the pulled-out object in an indicated direction switching their positions. The unit 41 then updates the position column of the object management table 60 accordingly. In this way, objects can be moved in the game field. When a control input provided via, for example, a button of the controller 20 is acknowledged while the object being pulled out, the unit 41 shows the pulled-out object being pushed back and returned its position and updates the status column of the object management table 60 accordingly. The button for pulling out an object and the button for returning the object to its position may be the same button.

Upon acknowledging a control input for pulling out an object, the object arrangement modification unit 41 refers to the orientation column of the object management table 60. When the associated object is arranged in an inverted orientation, the unit 41 displays the object as being rotated so as to be oriented properly as the object is being pulled out, and updates the orientation column of the object management table 60 accordingly. Thus, any object arranged in an orientation different from the proper orientation can be automatically oriented properly in response to an operation of pulling out the object. Therefore, the user operation is simplified and the game is enjoyed in a leisurely manner. By mixing objects in an orientation different from the proper orientation in the arrangement, a twist is added to the appearance or playability of the game.

The determination unit 42 identifies objects that match an arrangement condition for grouping some of the multiple objects arranged in the game field. The unit 42 groups the objects that match the arrangement condition. In this embodiment, when objects that should be arranged adjacent to each other are properly placed in adjacent positions and in order, those objects are grouped. When the determination unit 42 determines that multiple objects should be grouped, the unit 42 stores, in the group ID column of the object management table 60, the object ID of an object that belongs to the group and that is assigned the smallest object ID. The multiple objects thus grouped are handled as a single object subsequently. The object arrangement modification unit 41 moves the group as a whole in a block instead of moving the multiple objects belonging to the group individually. This simplifies the user operation and allows the user to enjoy the game in a leisurely manner.

Even when the objects that should be arranged adjacent to each other are properly placed in adjacent positions, the determination unit 42 does not group the objects when any of the objects is arranged in an orientation different from the proper orientation.

A description will now be given of the detail of the operation of the game with reference to the drawings. When the control unit 40 acknowledges a request to start the game from the user, the unit 40 determines the arrangement of books by, for example, generating random numbers. The unit 40 stores the positions and orientations of books thus determined in the object management table 60. The determination unit 42 refers to the object management table 60 and identifies books that should be grouped in the arrangement at the beginning of the game. In the example shown in FIG. 3, volume 7 is placed in the first position, volume 8 is placed in the second position, and so the books that should be arranged adjacent to each other are placed in adjacent positions. Therefore, volumes 7 and 8 are grouped. The determination unit 42 stores in the object management table 60 the object ID of volume 7, which belongs to the group and which is assigned the smallest object ID, as the group ID of the volumes 7 and 8 as grouped. In the example shown in FIG. 3, volume 9 is placed in the fourth position, and volume 10 is placed in the fifth position, and so the books that should be arranged adjacent to each other are placed in adjacent positions. However, volume 9 is arranged in an inverted orientation so that the determination unit 42 does not group volumes 9 and 10. As mentioned below, once volume 9 is pulled out, the object arrangement modification unit 41 automatically orients the book properly. Therefore, pushing the book back allows the determination unit 42 to group volumes 9 and 10. The screen generator 66 reads data necessary to generate images (e.g., image data for the game field and image data for books) from the storage unit 62, generates a display screen based on the information stored in the object management table 60, and displays the data on the display device 68.

FIG. 4 shows an example screen displayed when the game is started. The game screen 70 displays multiple books arranged at random and a cursor 72 showing the book subject to movement. A graphic form 73 indicating that multiple books are grouped is displayed. When the user uses, for example, a cross key assigned the function of moving the cursor rightward or leftward, the object arrangement modification unit 41 changes the position of the cursor. In the example shown in FIG. 4, the volume number of the books is displayed slightly displaced from the center of the spine of the book. This allows that user to readily see that there are books arranged in an inverted orientation and to see the volume number easily even if there are inverted books.

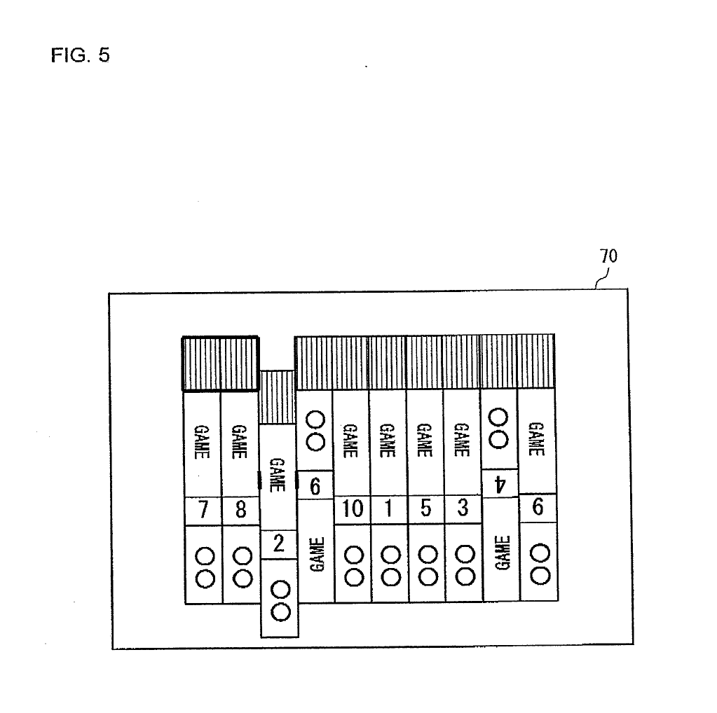

When the user uses a button assigned the function of pulling out a book for relocation, the object arrangement modification unit 41 changes the entry in the status column for the book at the cursor position to “1”. As shown in FIG. 5, the screen generator 66 generates a game screen in which volume 2 is displayed as being pulled out. In this process, the screen generator 66 may display the book pulled out as appearing smaller than the other books. This allows the user to readily see that the book is pulled out and prevents the book thus pulled out from screening the adjacent books.

When the user provides an input using a horizontal key of the cross key while volume 2 is being pulled out, the object arrangement modification unit 41 moves volume 2 in the direction indicated by the input and updates the position column of the object management table 60. In addition to volume 2, the position column of the object management table 60 is updated for those books that are moved in association with the movement of volume 2.

When the user provides an input using a certain button (e.g., the L button or R button) while the book at the cursor position is being pulled out, the object arrangement modification unit 41 moves the book thus pulled out to the left or right end, updating the position column of the object management table 60 accordingly. The object arrangement modification unit 41 may move the cursor position to the right or left end when the user provides an input using the L button or R button while the book at the cursor position is not being pulled out. The user can move the position of the cursor or the book one step at a time to the right or left, using the cross key. The user can also move the cursor or the book to the right or left end in a single step, using the L button or R button. The user may use an appropriate method of moving depending on the situation. This improves the playability of the game.

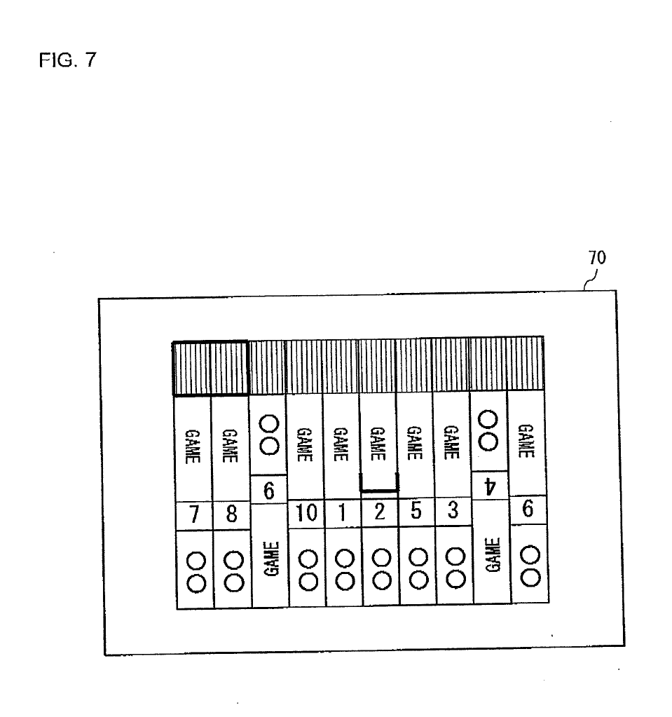

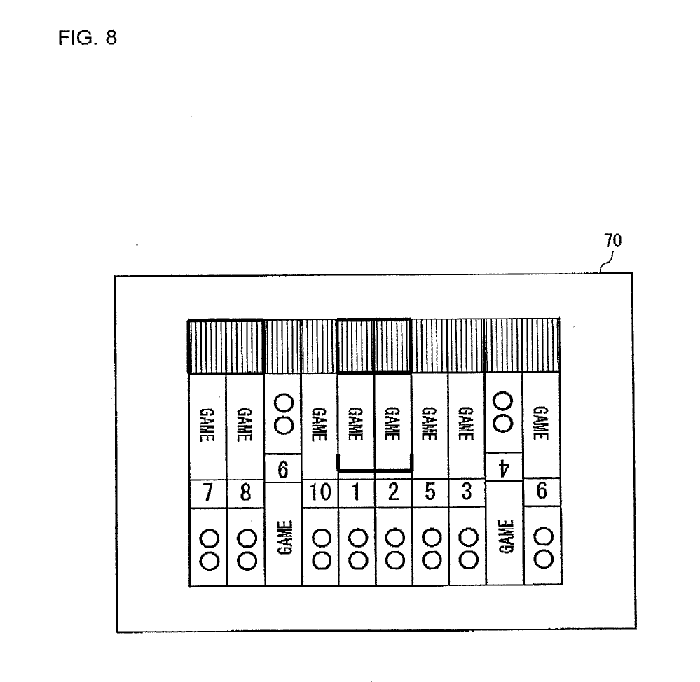

When the user provides an input using a button while volume 2 is being pulled out, the object arrangement modification unit 41 returns the book that had been pulled out to its original position, as shown in FIG. 7, and updates the status column of the object management table 60 accordingly. In this process, the determination unit 42 determines whether the book thus returned and any of the adjacent books should be grouped. In the example of FIG. 7, volume 1 is placed to the left of volume 2 and so volumes 1 and 2 are properly placed in adjacent positions. Accordingly, the determination unit 42 groups volumes 1 and 2, updating the group ID column of the management table 60 to “01”. As shown in FIG. 8, the screen generator 66 displays a graphic form indicating that volumes 1 and 2 are grouped. Since volumes 1 and 2 are moved in a block subsequently, the cursor is also changed to include volumes 1 and 2.

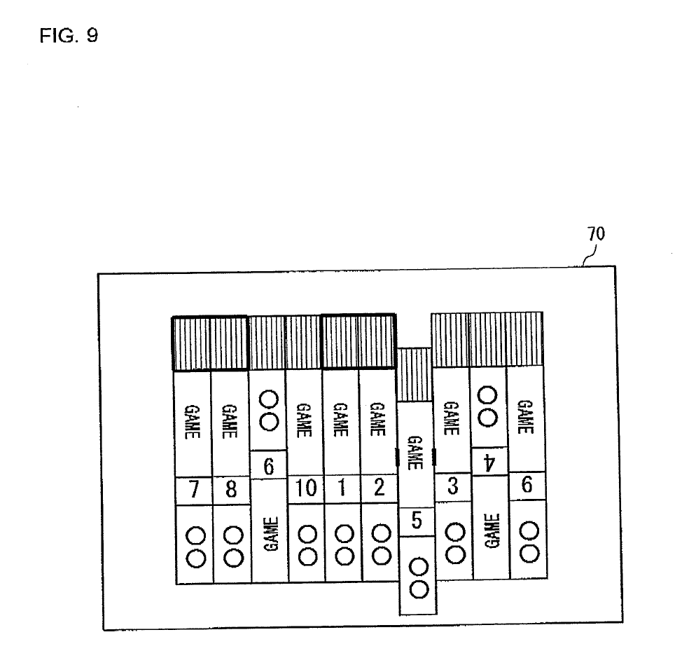

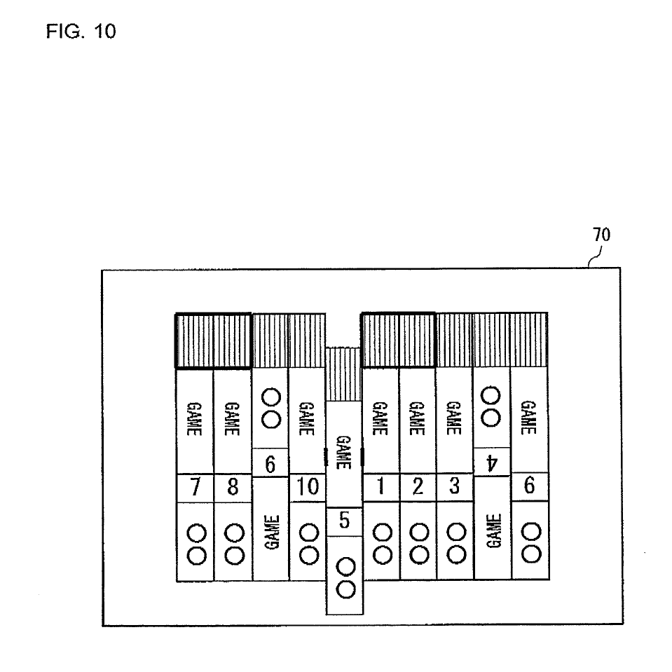

It will be assumed that, as shown in FIG. 9, the user provides an input using the left key of the cross key while volume 5 is being pulled out. In this process, the object arrangement modification unit 41 replaces volume 5 and the book to the left thereof in order to move volume 5 leftward. Since the group of volumes 1 and 2 is placed to the left of volume 5, the object arrangement modification unit 41 replaces volume 5 by the group of volumes 1 and 2, as shown in FIG. 10.

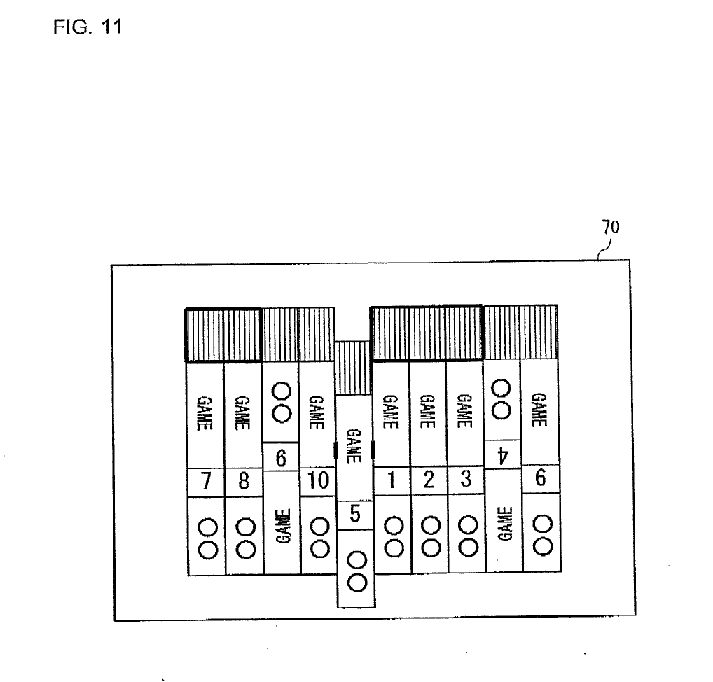

In this process, the object arrangement modification unit 41 determines whether there are books that should be grouped as a result of rearrangement. In the example of FIG. 10, the group of volumes 1 and 2 and volume 3 are properly placed in adjacent positions. Therefore, the unit 41 groups these three volumes of books, as shown in FIG. 11. In this process, the determination unit 42 updates the group ID of the three volumes of books in the object management table 60 to “01”, which is the smallest of the object IDs of the three volumes of books. Since volumes 1 and 2 are already assigned the group ID “01”, only the group ID of volume 3 is updated. That the group includes 3 books may be indicated by storing “3” in the group ID column of the record with the object ID “01”.

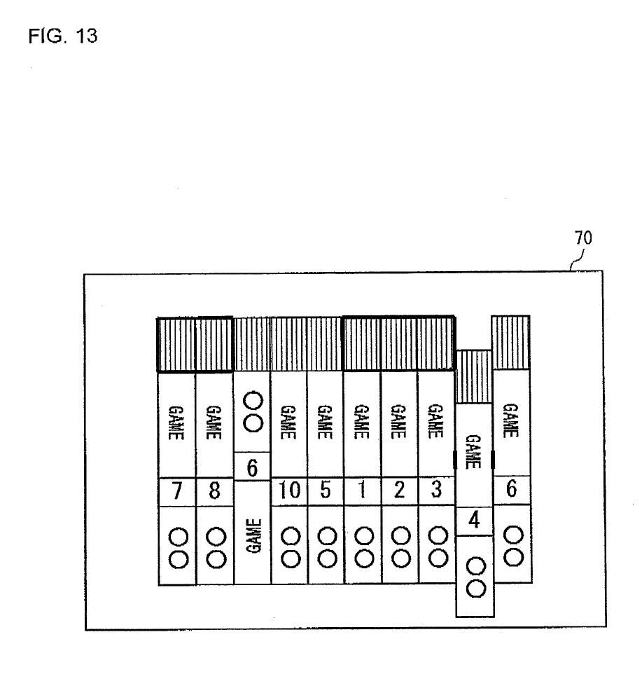

When the user provides an input using a button while the cursor is over volume 4 in an inverted orientation, the object arrangement modification unit 41 displays the book as being pulled out such that the book is automatically rotated 180° and is thus oriented properly, as shown in FIG. 13.

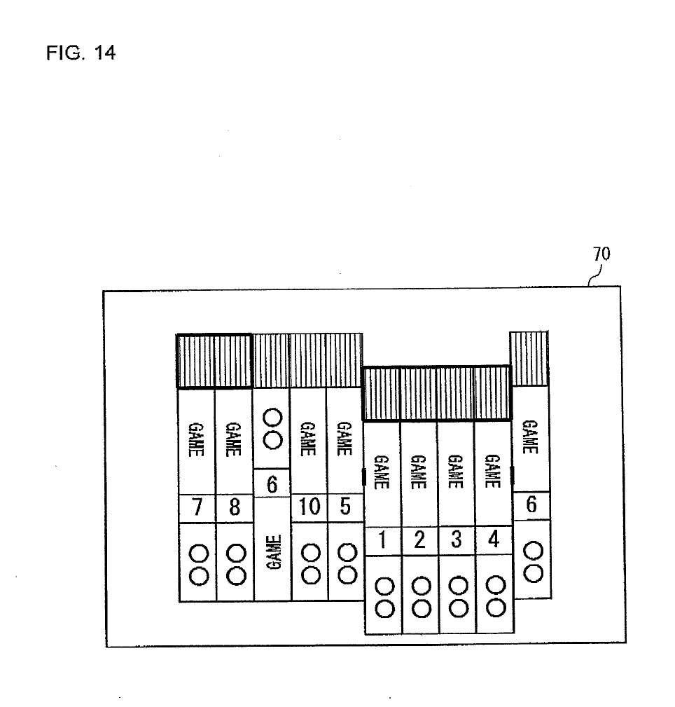

The grouped books are moved in a block instead of being moved individually. Therefore, when the user provides an input using a button while the cursor is over the grouped books, all books belonging to the group are pulled out, as shown in FIG. 14. When the user provides an input in this state using a horizontal key of the cross key, the object arrangement modification unit 41 moves the group rightward or leftward in a block.

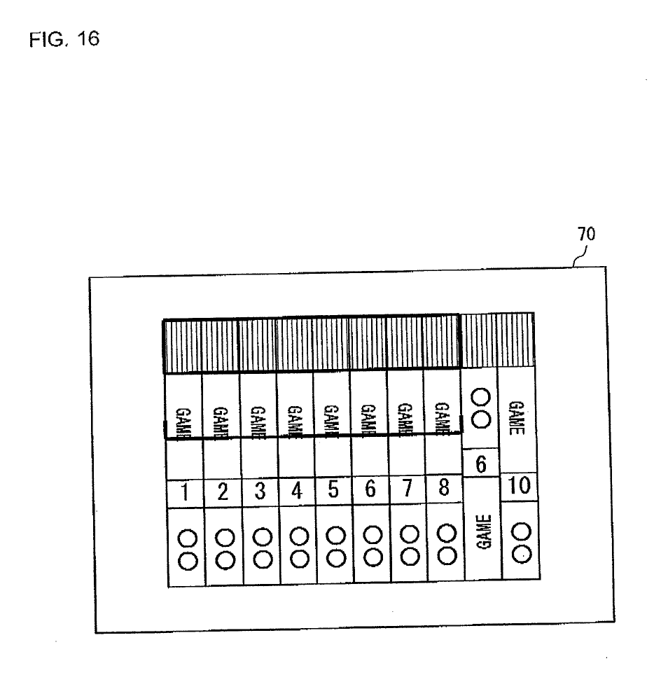

When a group of six books comprising volumes 1 through 6 is moved to the left of a group of two books comprising volumes 7 and 8 and is pushed, the determination unit 42 determines whether the group comprising volumes 1 through 6 and the group comprising volumes 7 and 8 are properly placed in adjacent positions. In this case, the two groups are properly arranged in adjacent positions. Therefore, as shown in FIG. 16, the determination unit 42 groups the group comprising volumes 1 through 6 and the group comprising volumes 7 and 8. In this process, the determination unit 42 updates the group IDs of volumes 7 and 8 in the object management table 60 from “07” to “01”. Since the group comprising volumes 1 through 6 is already assigned the group ID “01”, the group ID is not updated. This results in volumes 1 through 8 being all assigned the group ID “01” so that these books are treated as a group.

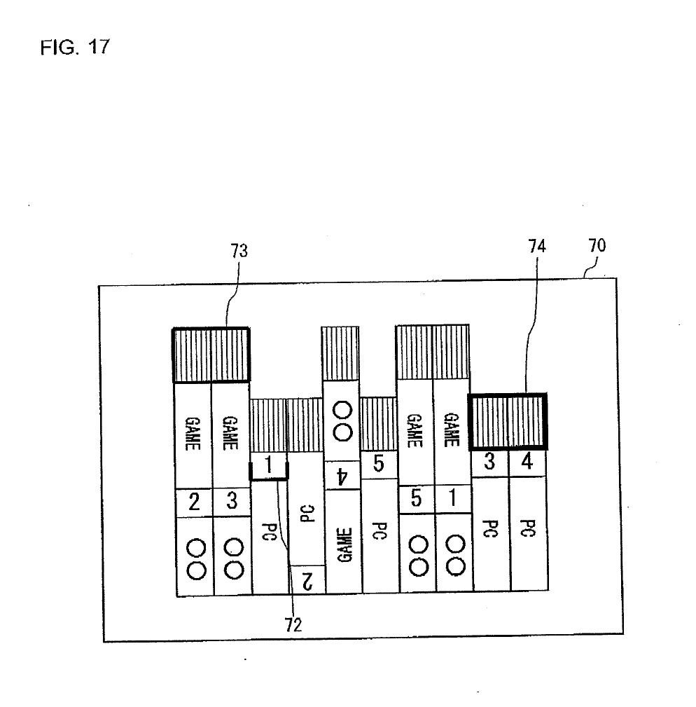

As shown in FIG. 17, multiple types of objects may be mixed. In this case, the order of arrangement that allows for the types of objects may be established. Alternatively, the order of arranging the types of objects may be irrelevant. For example, books on “game” may be placed to the left of books on “PC” in the example of FIG. 17. Alternatively, books on “game” may be placed to the left or right of books on “PC” so long as books on “game” are arranged in order and books on “PC” are arranged in order, respectively.

In the example of FIG. 17, volume 2 on “game” and volume 3 on “game” are properly arranged in adjacent positions so that a graphic form 73 indicating that the objects are grouped is displayed. Further, volume 3 on “PC” and volume 4 on “PC” are properly arranged in adjacent positions so that a graphic form 74 indicating that the objects are grouped is displayed. The graphic form 73 and the graphic form 74 indicate groups of different types of objects and so may be displayed in different modes. This will show the groups as including different types of objects in a visually appealing manner.

Given above is a description based on an embodiment. The embodiment is intended to be illustrative only and it will be obvious to those skilled in the art that various modifications to constituting elements and processes could be developed and that such modifications are also within the scope of the present invention.

The description above concerns an example where books are arranged in the order of volumes. However, any arrangement may be used so long as the order is defined according to a predefined rule and the proper order is recognized by the user. For example, objects indicating historical events may be arranged in the chronological order, objects indicating names of stations included in a railroad line may be arranged in the order of stations trains stop at or pass by, or objects each indicating a part of a picture or a photo may be arranged properly so as to reconstruct the picture or the photo.

What is claimed is:

1. A game control program embedded in a computer readable recording medium, comprising:
a module adapted to acknowledge selection of an object subject to movement from among a plurality of objects arranged in one direction in a game field;
a module adapted to move the selected object to a position requested by a user; and
a module adapted to refer to a table storing a proper order of arrangement of the plurality of objects, determine whether objects that should be arranged adjacent to each other are properly placed in adjacent positions, and group those objects that are properly placed in adjacent positions if any, wherein
the module for moving moves the plurality of objects belonging to a group in a block when the grouped objects are selected.

2. The game control program according to claim 1, wherein
the module for determining determine whether an object that is moved by the module for moving and an object adjacent to the moved object are properly placed in adjacent positions.

3. The game control program according to claim 1, further comprising:
a module adapted to arrange, when an object placed in an orientation different from a proper orientation is selected, the selected object properly and automatically.

4. The game control program according to claim 1, wherein
the module for determining does not group, when objects that should be arranged adjacent to each other are properly placed in adjacent positions but when any of the objects is placed in an orientation different from a proper orientation, the objects thus arranged.

5. The game control program according to claim 1, wherein
the plurality of objects include a plurality of types of objects.

6. The game control program according to claim 5, further comprising:
a module adapted to show a graphic form indicating grouping in the neighborhood of the grouped objects grouped by the module for grouping, wherein
the module for displaying a graphic form displays the graphic form in different modes for groups of different types of objects.

7. A game device comprising:
an object arrangement modification unit adapted to acknowledge selection of an object subject to movement from among a plurality of objects arranged in one direction in a game field, and to move the selected object to a position requested by a user;
a determination unit adapted to refer to a table storing a proper order of arrangement of the plurality of objects, determine whether objects that should be arranged adjacent to each other are properly placed in adjacent positions, and group those objects that are properly placed in adjacent positions if any, wherein
the object arrangement modification unit moves the plurality of objects belonging to a group in a block when the grouped objects are selected.

8. A game control method comprising:
acknowledging selection of an object subject to movement from among a plurality of objects arranged in one direction in a game field;
moving the selected object to a position requested by a user; and
referring to a table storing a proper order of arrangement of the plurality of objects, determining whether objects that should be arranged adjacent to each other are properly placed in adjacent positions, and grouping those objects that are properly placed in adjacent positions if any, wherein
the step for moving moves the plurality of objects belonging to a group in a block when the grouped objects are selected.

9. A computer readable recording medium having embodied thereon the game control program according to claim 1.
